(19) United States
(12) Patent Application Publication
(10) Pub. No.: US 2023/0099331 A1
(43) Pub. Date: Mar. 30, 2023

(54) MACHINE TOOL, ESPECIALLY FOR ALL-SIDED MACHINING OF TORIC WORKPIECES

(71) Applicant: P&L GMBH & CO. KG, Soltau (DE)

(72) Inventor: Jürgen RÖDERS, Soltau (DE)

(21) Appl. No.: 17/909,895

(22) PCT Filed: Feb. 24, 2021
(86) PCT No.: PCT/EP2021/054532

§ 371 Date: Sep. 7, 2022

(30) Foreign Application Priority Data
Mar. 12, 2020 (DE) 10 2020 203 185.1

(51) Int. Cl. B23Q 1/54; B23Q 1/01; B23Q 1/48

(52) U.S. Cl. CPC B23Q 1/5406; B23Q 1/015; B23Q 1/4876

(57) ABSTRACT

A machine tool includes a Z-slider with a main spindle rotating about a spindle axis, a main body on which the Z-slide is arranged, a machining table with a machining plane, a clamping device for clamping a workpiece, and a first drive to rotate the clamping device about an rotational axis. A support member is arranged on a pivot-axis housing on which the machining table is arranged. A second drive pivots the support member and the machining table about a pivot axis. The support member has first and second legs. The machining table is arranged on the first leg such that the support member and the housing form a U-shaped unit and provide an interspace between the second leg and the housing, into which interspace a toric workpiece clamped on the clamping device can project and is rotatable about the axis of rotation by the first drive.

The present invention relates to a machine tool, especially for all-sided machining of toric workpieces.

Machine tools are known from the prior art in various designs. For multi-sided milling of toric workpieces, 5-axis machines are usually used. It is particularly challenging to machine flow components owing to the high surface qualities required, e.g. for aircraft turbines. It is particularly difficult to machine closed flow components such as BLINGS. The flow areas of the buckets require machining from both sides. For this purpose, it is necessary to turn the workpiece and reclamp it following one-side machining operation. If machining is performed at the second side, distortions of the workpiece, etc. will occur, due to minor clamping errors, which may result in a recess in the region that was machined during the first clamping, when the flow area is machined.

It is therefore the object of the present invention to provide a machine tool which is capable of machining especially toric workpieces in a single clamping session and having simple design and can be manufactured in a simple and inexpensive manner.

This object will be achieved by providing a machine tool having the features of claim 1. Preferred further embodiments of the invention are shown in the subclaims.

The machine tool according to the invention having the features of claim 1 has the advantage that a workpiece may fully be machined in a single clamping session. The machine tool is especially adapted for the machining of toric workpieces, such as flow components of gas turbines, e.g. BLINGs. The machine tool comprises a Z-slider including a main spindle for receiving a tool holding device rotating about a spindle axis with a machine tool, for example a milling cutter, clamped therein. Furthermore, the machine tool comprises a machine main body on which the Z-slider is arranged. Furthermore, a machining table of the machine tool comprises a machining plane, a clamping device for clamping a workpiece, and a first drive arranged in a housing. The first drive is arranged to execute a rotation of the clamping device of the machining table about a rotation axis. Furthermore, the machine tool comprises a support member arranged on a pivot axis housing on the main body of the machine. Herein, the machining table is arranged on the support member. In this case, the support member comprises a one-sided hinged cantilever arm articulated on one side and having a substantially L-shaped form. Furthermore, a three-axis linear motion system with a first, second and third linear axis is provided to perform a relative motion between the Z-slider and the machining table. A second drive is also provided, which is configured to allow pivoting about a pivot axis of the support member together with the machining table. Thus, the clamping device on the machining table is rotatable about two different axes, namely the rotational axis driven by the first drive and the pivot axis driven by the second drive.

Furthermore, the L-shaped support member comprises a first and a second leg. The machining table with the housing is arranged on the first leg at the free end of the first leg such that the support member and the housing of the machining table substantially form a U-shaped unit, leaving an interspace between the second leg, which is arranged on the pivot axis housing, and the housing of the machining table. The interspace is arranged as a workpiece receiving area to receive a portion of the workpiece. Thus, a workpiece part projects into the interspace and is located between the machining table and the second leg of the support member. Herein, especially a machine tool mounted in the main spindle can be moved into the interspace and machine the workpiece in the interspace. Preferably, the main spindle can also be moved into the interspace.

In this way, it may be ensured that simple machining of a workpiece fixed onto the machining table can safely be performed in one clamping session from all directions using the machine tool and can be performed without the risk for the machine tool and the tool holding device as well as the main spindle or the Z-slider to collide with the housing components of the machine tool or the workpiece.

Accordingly, in addition to the spindle axis of the main spindle, the machine tool comprises five axes, two of which are provided for rotation of the clamping device of the machining table about different axes. Thus, the workpiece, which is clamped onto the machining table using the clamping device, is rotatable about the rotational axis in the working area of the machine tool and pivoted about the pivot axis by means of the support member. As a result, toric workpieces can be machined safely and with maximum accuracy in a single clamping session by the machine tool. The machine tool according to the invention is especially suitable for the production of flow components, in particular turbine components.

The support member, which is designed as a cantilevered L-shaped arm, allows a spacing between the housing of the machining table and the support member in the form of the interspace, which interspace gives space for a toric workpiece to be clamped using the clamping device, especially such that the machining table is located essentially inside the toric workpiece. The toric workpiece is arranged at least partially in this interspace of the U-shaped unit of support member and housing of the machining table.

The machining table is arranged in a cantilevered manner on the first leg of the L-shaped support member on the free end of the first leg. The L-shaped support member, together with the rotational axis and the pivot axis, allows simple, fast and safe all-sided machining of the workpiece.

Thus, the first leg of the L-shaped support member, on which the machining table is arranged, is designed to be long enough to create an interspace between the housing of the machining table and the second leg of the L-shaped support member, forming the interspace and leaving sufficient space for the toric workpiece to be clamped to the clamping device of the machining table. This allows the workpiece to be rotated without collision between the housing of the machining table and the second leg of the L-shaped support member by means of the first drive.

For a particularly compact and simple design, the first drive is preferably arranged directly in the machining table. In this case, a drive axis of the first drive is located in the rotational axis of the machining table. The rotational axis preferably runs in the vertical direction when the pivot axis is in the 0° position.

The pivot axis housing is preferably part of the main body of the machine or is preferably located on a carriage that is movable in the main body of the machine along one or more linear axes.

Further preferably, the second drive is arranged directly on the support member, especially on the second leg, preferably within the pivot axis housing, so that the support member pivots about the pivot axis. Since the machining table is arranged on the support member, the machining table in turn also pivots together with the support member about the pivot axis.

Preferably, the support member, the machining table with the first drive and the pivot axle housing with the second drive form a single assembly unit. This means that those components can be provided as a pre-assembled unit. Furthermore, this ensures that particularly rigid design is possible between the support member and machining table components and the two drives. Thus, by moving about the pivot axis and the rotational axis, a workpiece clamped on the clamping device of the machining table can be positioned in the working space of the machine tool in any angular orientation.

Further preferably, the pivot axis is arranged in a machining plane of the machining table, or is arranged wherein the machining plane in the 0° position of the pivot axis is located below the clamping device of the machining table. Thus, a center of the machining table and consequently also the center of a workpiece clamped at the clamping device of the machining table always remains in the pivot axis, regardless of an angular position of the pivot axis.

Particularly preferably, the rotational axis and the pivot axis are arranged perpendicular to each other.

According to another preferred embodiment of the invention, a diameter of a housing of the machining table is larger than a width of the support member. This allows the support member to be made as maximally narrow, yet sufficiently stable. As a result, the workpiece clamped on the machining table can be easily machined from all sides without interference of the support member. Thus, particularly good accessibility of the workpiece for machining can be realized.

For example, the workpiece can be clamped to the clamping device using a pallet such that it essentially is located in the machining plane, i.e. below the clamping device of the machining table when the pivot axis is in the 0° position. Consequently, the machining table with the first drive is located especially inside the toric workpiece. It is particularly advantageous if the housing of the machining table has the diameter maximally small, but the first drive is sufficiently powerful to hold the toric workpiece during machining. This allows simple and safe all-sided.

The pivot axis housing, within which the second drive is preferably arranged, is preferably arranged on a carriage which is movable in the main machine body along a linear axis, and especially relative to the Z-slider. Particularly preferably, the assembly unit consisting of the machining table with first drive and clamping device, L-shaped support member and pivot axis housing with second drive is located on the slide, which is movably arranged along a linear axis, especially the third linear axis X, is located in the main body of the machine.

Particularly preferably, the Z-slider is movable in the first and second linear axes and especially is arranged vertically. The linear axes are especially also provided with drives. In this way, a simple structure of the machine tool may be achieved. Further preferably, the main machine body of the machine tool is designed essentially as a portal machine, and for example is C-shaped, wherein the assembly unit consisting of support member, machining table and pivot axis housing, especially on a carriage, are arranged in the center of the portal-shaped main machine body.

The drive of the rotational axis and/or the pivot axis is preferably a torque motor. This allows the first and second drives to have the diameter maximally small such that the first drive can smoothly be integrated into the machining table. This further improves accessibility to a workpiece located on the machining table. It is preferred that the machining table housing is only slightly larger than a diameter of the first drive.

Further preferably, a transition between the first leg and the second leg of the L-shaped support member is arcuate. Particularly preferably, a thickness of the second leg is smaller than a thickness of the first leg. As a result, the interspace between the second leg and the machining table is further increased.

In order to further increase the interspace between the second leg and the machining table, the housing of the machining table is preferably designed to protrude beyond the free end of the first leg in the direction of the pivot axis. As a result, the machining table is arranged on the first leg with maximum distance from the second leg, so that the interspace between the second leg and the machining table can be selected by choosing a length of the first leg of the L-shaped support member.

In order to also ensure collision-free machining of the workpiece clamped onto the machining table when the L-shaped support member is rotated by 180° about the pivot axis, a chamfer is formed at the free end of the first leg on a side opposite the machining table. The chamfer is preferably conical and allows collision-free machining on the inner edges and outer edges of a toric workpiece as well as on a bottom or top side of the toric workpiece.

Particularly preferably, a cross-section of the first leg of the support member is trapezoidal. In this case, a width on an upper side of the support member on which the machining table is arranged is wider than a width on the opposite lower side. This also greatly simplifies machining of the workpiece when pivoted by 180° about the pivot axis.

Preferably, the housing of the machining table is cylindrical.

Further preferably, a portion of the main spindle and a tool holding device mounted thereon can be moved with the tool in the direction of the second linear axis below the pivot axis. This means that the workpiece can also be machined in regions that are far below the pivot axis for the support member. This allows a wide variety of workpieces to be machined in just a single clamping session. The interspace forms a workpiece holding area where a portion of the workpiece can be held. It is also possible to machine regions of the workpiece that are located in the interspace.

In the following, a preferred embodiment of the invention will be described in detail while reference will be made to the accompanying drawing, wherein:

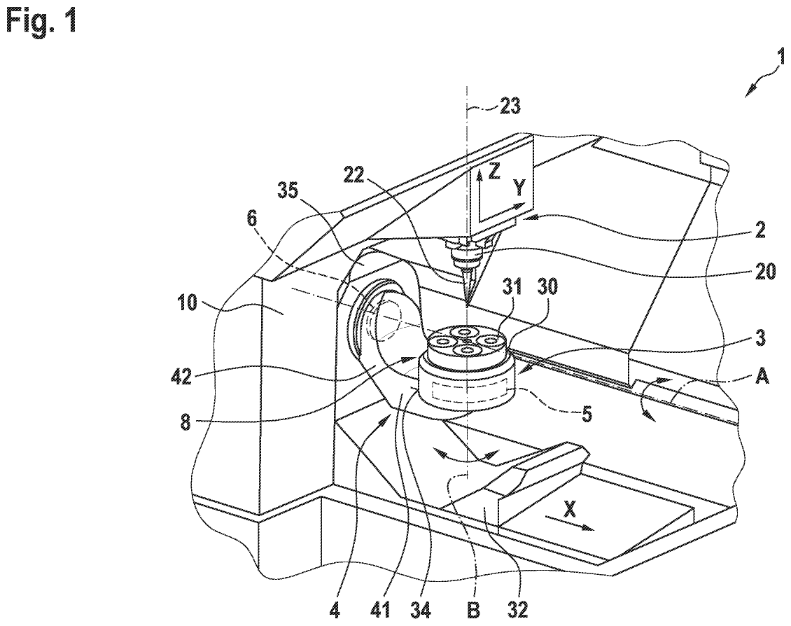

FIG. 1 is a schematic, perspective view of a machine tool according to a preferred embodiment of the invention in a first position,

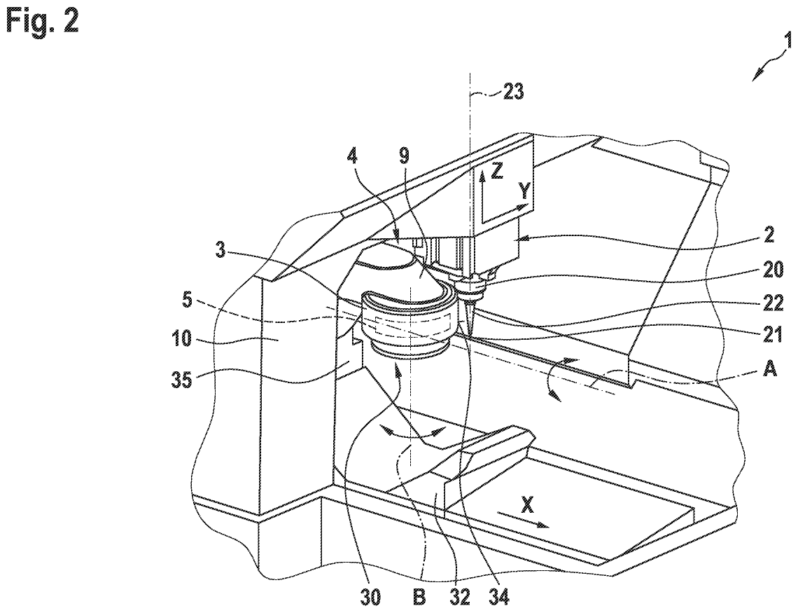

FIG. 2 is a schematic, perspective view of the machine tool of FIG. 1 in a second position of the pivot axis rotated by 180°,

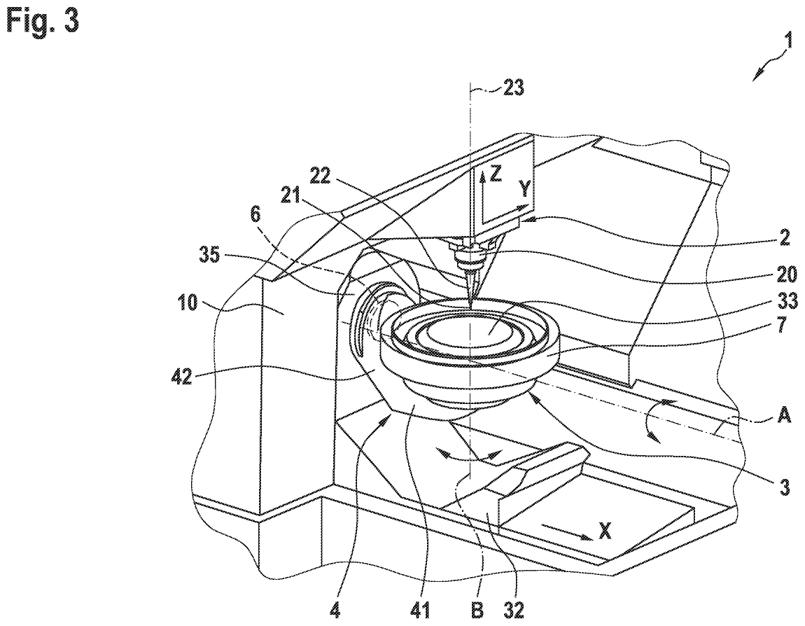

FIG. 3 is a schematic, perspective view of the machine tool of FIG. 1 in the first position with the workpiece clamped,

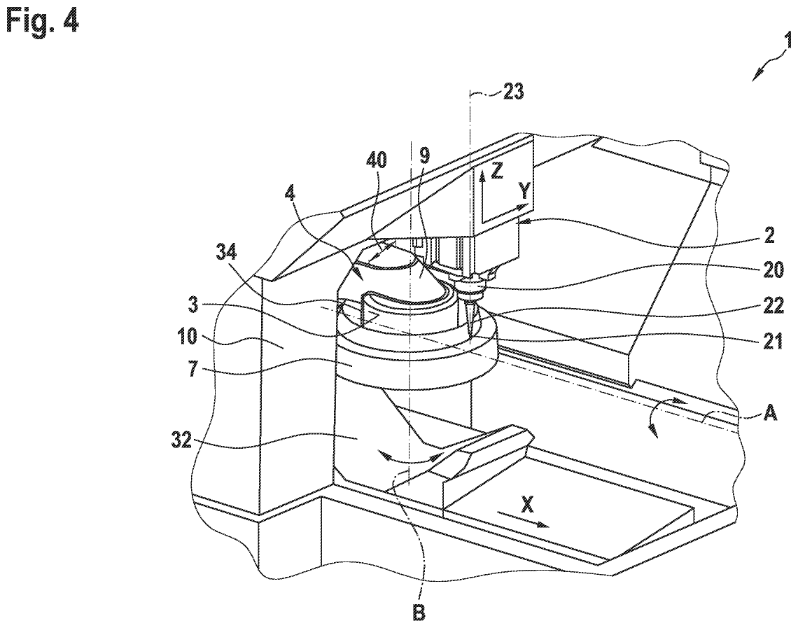

FIG. 4 is a schematic, perspective view of the machine tool of FIG. 2 in the second position with the workpiece clamped,

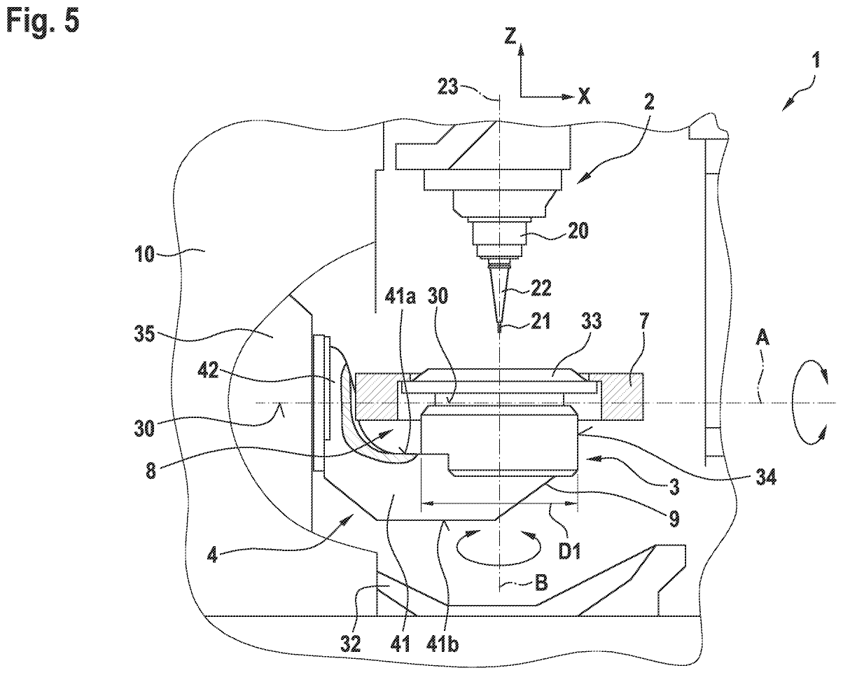

FIG. 5 is a schematic, partially cut side view of the machine tool of FIG. 1 with the workpiece clamped in the first position,

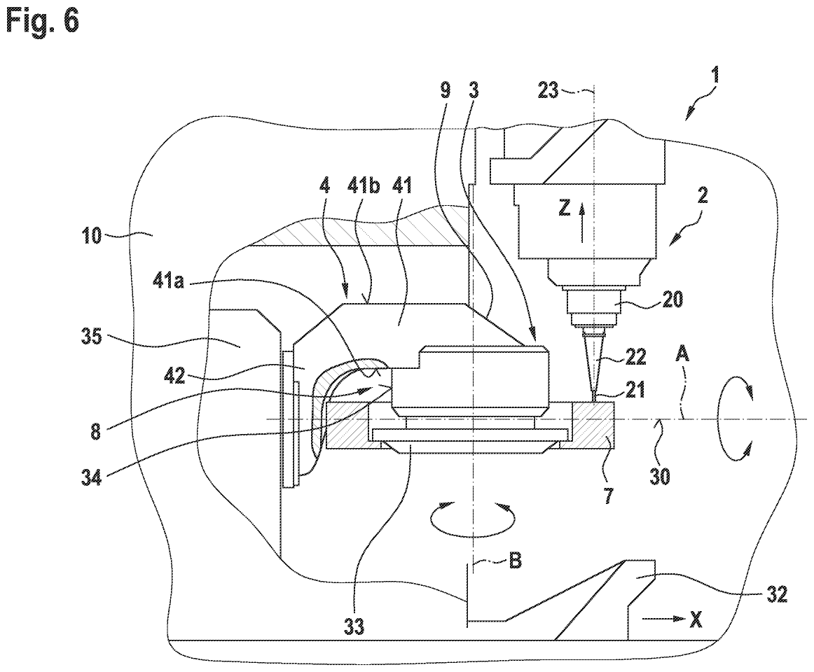

FIG. 6 is a schematic, perspective view of the machine tool of FIG. 2 in the second position with the workpiece clamped,

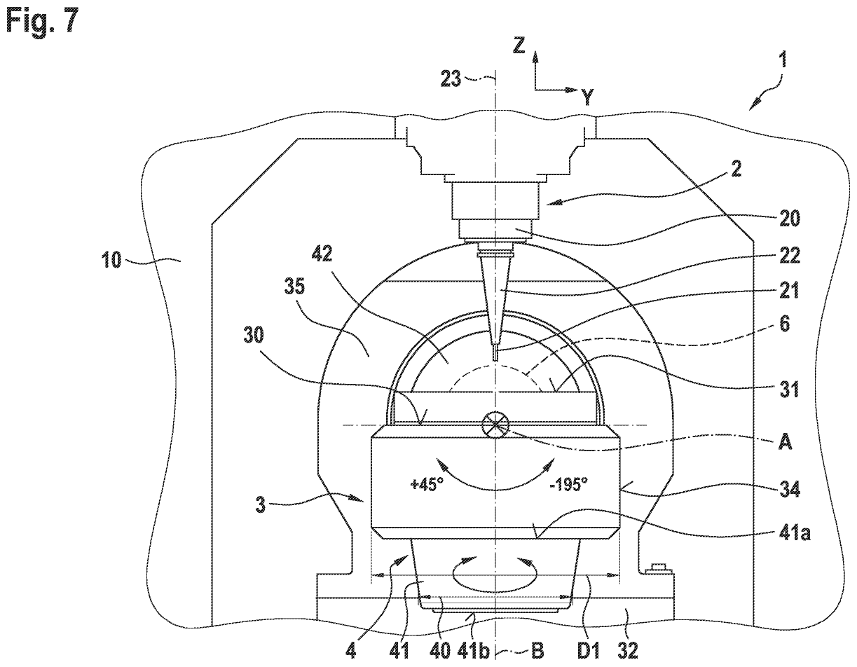

FIG. 7 is a schematic front view of the machine tool of FIG. 1 without workpiece in the first position, and

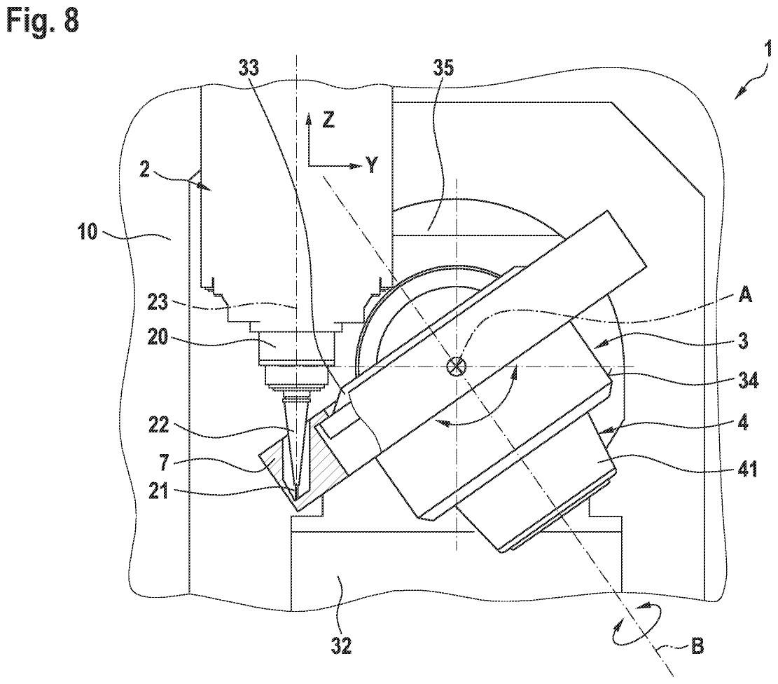

FIG. 8 is a schematic front view of the machine tool in a third position.

In the following, a machine tool 1 according to a preferred embodiment of the invention will be described in detail while making reference to FIGS. 1 to 8.

As can be seen from FIG. 1, the machine tool 1 comprises a main machine body 10 which is substantially portal-shaped. It should be noted that other basic machine shapes are also possible.

The machine tool 1 comprises a Z-slider 2 with a main spindle 20. The main spindle 20 is arranged to receive a tool holding device 22 with a machine tool 21, for example a milling cutter (cf. FIGS. 5 and 6).

The machine tool 1 further comprises a machining table 3 with a machining plane 30, wherein a workpiece 7 can be clamped to the machining table 3 using a clamping device 31.

For mounting to the machining table 3, the workpiece 7 can be attached to a pallet 33 and the pallet 33 can be clamped to the machining table 3 using the clamping device 31 (cf. FIGS. 3 and 6). In the 0° position of the pivot axis A, the workpiece 7 is essentially located below the pallet 33 and thus in the machining plane 30. As a result, the machining table 3 is located within the workpiece 7. The machining plane 30 is preferably located in the pivot axis A or in the 0° position below the pivot axis A.

The machining table 3 has a first drive 5, which is rotatable 360° in both directions about a rotation axis B to rotate the clamping device 31 mounted on the machining table 3. The first drive 5 is completely accommodated in a cylindrical housing 34.

Furthermore, the machine tool 1 comprises a support member 4, which is arranged on a pivot axis housing 35 of the main machine body 10. The support member 4 is pivotable about a pivot axis A relative to the pivot axis housing 35 by means of a second drive 6.

As can be seen from FIGS. 1, 5 and 6, the support member 4 is an L-shaped cantilever arm with a first leg 41 and a second leg 42. The machining table 3 together with the first drive 5 is arranged at the free end of the first leg 41 (cf. FIGS. 1 and 2). Herein, the machining table 3 is placed on the first leg 41 of the L-shaped support.

As can especially be seen from the side view of FIG. 5, the machining table 3 with the housing 34, in which the first drive 5 is arranged, is arranged at the free end of the first leg 41 on the first leg 41. This results in a substantially U-shaped unit, comprising the support member 4 and the machining table 3. This results in an interspace 8 between the second leg 42 and the housing 34 of the machining table. This allows a toric workpiece 7 to be clamped to the clamping device 31 using a pallet 33 such that a portion of the workpiece 7 is located in the interspace 8 and can freely be rotated by means of the rotation axis B. A machining tool 21 mounted on the main spindle 20 can be moved into the machining plane 30 even if the pivot axis A is not at 0° or 180° (see FIG. 8). Thus, the toric workpiece 7 can be machined from all sides in a single clamping session.

A portion of the main spindle 20 and the tool holding device including the tool mounted thereto can be moved in the direction of the second linear axis Z to below the pivot axis A. In this way, for example, deep holes can also be realized in the workpiece 7.

As the support member 4 including the machining table 3 can also be rotated about the pivot axis A, machining of the workpiece 7 on the side of the workpiece 7 facing the support member 4 may also be smoothly performed. In this case, the workpiece 7 can also be rotated about the axis of rotation B so that the portions of the workpiece 7 which are covered by the support member 4 in this position can also be machined. It is also possible to machine the workpiece 7 in an inclined position, as indicated in FIG. 8.

To ensure the interspace 8 between the second leg 42 and the housing 34 to be maximally large, a transition between the first and second leg 42 is curved and the second leg 42 is very flat. Furthermore, the machining table is positioned on the first leg 41 such that the machining table protrudes in the direction of the pivot axis A beyond the free end of the first leg 41 (cf. FIG. 5). Herein, the first leg 41 has a top side 41a, facing towards the interspace 8, and an opposite bottom side 41b.

A chamfer 9 is formed on the bottom side 41b at the free end of the first leg 41. Especially in the position starting from the 0° position of the pivot axis A, which is shown in FIG. 5, collision-free machining of the workpiece 7 by the tool 21 may be performed due to the chamfer 9 located in a position pivoted by 180° about the pivot axis A (FIG. 6). By combining the chamfer 9 with the machining table 3 projecting beyond the free end of the first leg 41 in the direction of the pivot axis A, machining on an inner side of the toric workpiece 7 can also be realized. The chamfer 9 prevents collision between the main spindle 20 and the support member 4.

As can further be seen from FIG. 7, a cross-section of the first leg 41 of the support member 4 is trapezoidal in shape. Herein, a width at the upper side 41a on which the machining table 3 is arranged is wider than a width at the opposite lower side 41b. This results in the support member 4 to be slimmer on the bottom side 41b, so that in the machining position shown by 180° in FIG. 6, especially lateral machining of the toric workpiece 7 will be simplified.

It is preferred that the first and second drives 5, 6 are torque motors with a high torque. In this case, the support member 4 and the machining table 3 together with the first and second drive 5, 6 are provided as a pre-assemblable unit.

As further indicated in FIG. 1, the Z-slider 2 is movable in two directions, namely a first linear axis Y and a second linear axis Z perpendicular thereto. Furthermore, the pivot axis housing 35 is arranged on a carriage 32. The carriage 32 is movable along a third linear axis X. It should be noted that, alternatively, the linear axes for relative movement between pivot axis housing 35 with support member 4 and machining table 3 and Z-slider 2 with main spindle 20 can also be divided differently, for example, pivot axis housing 35 together with support member 4 and machining table 3 can also be movable in the three directions X, Y, Z.

The tool holding device 22 mounted on the main spindle 20 is rotatable about a spindle axis 23. The spindle axis 23 is aligned in the vertical direction. The main spindle 20 is attached to the Z-slider 2.

As can be seen from FIGS. 1 and 2 or 3 and 4, the working plane 30 can be tilted to any position by rotation about the pivot axis A in a working space of the machine tool 1. In FIG. 7, a pivot angle of the pivot axis A is schematically shown starting from the 0° position in a range from +45° to −195°, especially starting from a horizontal plane. It should be noted, however, that the pivot angle about the pivot axis A can also be provided differently, depending on the area of application of the machine tool 1. Preferably, stops for limiting the pivot movement about the pivot axis A are provided at a starting point and an end point, respectively.

Thus, a 5-axis machine tool 1 is provided in which the machine tool 21 can additionally be rotated about the spindle axis 23. As can be seen especially from FIGS. 3 to 6, which show a workpiece 7 clamped with a pallet 33 onto the clamping device 31 at the machining table 3, machining of the workpiece 7 can be performed in a single clamping session by designing the support member 4 as an L-shaped support arm according to the invention. FIGS. 3 and 5 show a first position for machining in which the workpiece 7, which in this embodiment is a flow component having a plurality of circumferentially arranged buckets, is arranged in the horizontal plane at a 0° position of the pivot axis A. The workpiece 7 can be machined in a single clamping session This allows, for example, machining of the workpiece 7 from above by means of the machine tool 21 clamped in the main spindle 20 by a tool holding device 22 without restriction.

FIGS. 4 and 6 show a second machining position in which the machining table 3 and the support member 4 have been rotated 180° about the pivot axis A by rotation by means of the second drive 6. As a result, by means of the machining tool 21 clamped into the main spindle 20 by tool holding device 22, machining of the workpiece 7 on its underside can be made possible without having to reclamp the workpiece 7. Since the pivot axis A is preferably located in the machining plane 30, the position of the workpiece 7 relative to the linear axes X, Y and Z in the working space of the machine tool 1 hardly changes due to the 180° rotation of the pivot axis A. The workpiece 7 is located in the working space of the machine tool 1. It is in approximately the same location, only rotated 180°. In addition, machining of the workpiece 7 is possible at other pivot angles of the pivot axis A, since the machine tool 21 can be moved well below the pivot axis A, see FIG. 8.

Since the machining table 3 is located essentially within the workpiece 7 and the L-shaped support member 4 is provided as a cantilever arm which is pivotally mounted on the pivot axis housing 35 only in the region of the second leg 42, the workpiece 7 can be machined all around. Especially the clamping device 31 is rotatable on the machining table 3 by the first drive 5 about the axis of rotation B, which is perpendicular to the machining plane 30, so that the workpiece 7 can be machined from all sides without any problems. The interspace 8 between the second leg 42 and the housing 34 of the machining table 3 allows the workpiece 7 to partially protrude into the interspace 8. As a result, the machining plane 30 is located within the toric workpiece 7. The first drive 5 is thereby completely accommodated in the housing 34 of the machining table 3, so that the first leg 41 of the support member 4 can be designed to be very slim and flat.

Furthermore, due to the L-shaped support member 4, the pivot axis A can be arranged such that it always is located in the machining plane 30 of the machining table 3 or, for the position 0° of the pivot axis A, this is located below the clamping device 31. This can be seen in detail in FIGS. 6 and 7.

As can be seen from FIG. 5, the housing 34 of the machining table 3 has a diameter D1. The diameter D1 is slightly larger than a width 40 of the support member 4 (cf. FIGS. 4 and 7). This allows the toric workpiece 7 to be clamped to the machining table 3 such that a drive axis of the first drive 5 is located in the center of the toric workpiece 7.

As can be seen from FIG. 5, the housing 34 of the machining table 3 has a diameter D1. The diameter D1 is slightly larger than a width 40 of the support member 4 (cf. FIGS. 4 and 7). This allows the toric workpiece 7 to be clamped to the machining table 3 such that a drive axis of the first drive 5 is located in the center of the toric workpiece 7.

The L-shape of the support member 4 thus allows sufficient space for the toric workpiece 7 by providing the interspace 8, in particular between the second leg 42 and the housing 34 of the machining table 3, for clamping the workpiece 7 in the direction of the machining plane. The lengths of the first and second legs 41, 42 of the L-shaped support member 4 will thereby be adapted according to the requirements of the workpiece 7 to be machined, so as to be able to securely clamp it in the direction of the machining plane 30. The L-shaped support member 4 with arcuate transition between the first and second legs 41, 42 thus creates a free-standing machining table 3, so that a toric workpiece 7, as shown in FIG. 5, can be clamped such that the machining table 3 is substantially within the toric workpiece 7. In other words, the toric workpiece 7, for example, can be slipped over the machining table 3.

The L-shaped support member 4 is designed to be sufficiently stable, since it must support not only the workpiece 7, the pallet 33 and the clamping device 31, but also the first drive 5 for the machining table 3. In this case, the width 40 of the L-shaped support member 4 is selected to be smaller than the diameter D1 of the housing 34 of the machining table 3, so that there is optimum accessibility from all sides to the workpiece 7 to be machined. It should be noted that the first leg 41 is usually longer than the second leg 42, preferably at least twice as long as the second leg 42.

It should be noted that the L-shaped support member 4 and a housing 34 of the machining table 3 with integrated first drive 5 can be realized as two separate components or can be a single component unit. The L-shaped support member 4 may also have an integral flange to allow easy attachment to a shaft of the pivot axis A in the pivot axis housing 35.

Thus, according to the invention, a machine tool 1 can be provided which allows workpieces 7 machining, in particular toric workpieces 7 such as flow components, in particular BLINGs, in one clamping session using a support member 4 cantilevering a machining table 3. In this case, the support element 4 and the machining table 3 arranged on the support element 4 form a U-shaped unit with the interspace 8 between the second leg 42 and the housing 34 of the machining table 3, such that the workpiece 7 can also be clamped onto the machining table 3 deeply protruding into the interspace 8, and having the advantages set forth above during machining. This can significantly improve machining accuracy of such workpieces 7. Reduction in machining time may also be obtained as a result.

### LIST OF REFERENCE NUMBERS

1 Machine tool
2 Z-slider
3 Machining table
4 Support member
5 First drive
6 Second drive
7 Workpiece
8 Interspace
9 Chamfer
10 Machine main body
20 Main spindle
21 Machine tool
22 Tool holder
23 Spindle axis
30 Machining plane
31 Clamping device
32 Carriage
33 Pallet
34 Housing
35 Pivot axis housing
40 Width of support member
41 First leg
41a Top side
41b Bottom side
42 Second leg
A Pivot axis
B Rotational axis
D1 Diameter
Y First linear axis
Z Second linear axis
X Third linear axis

1. A machine tool comprising:
a Z-slider with a main spindle for a machine tool rotating about a spindle axis,
a machine main body on which the Z-slider is arranged,
a machining table having a machining plane, a clamping device for clamping a workpiece, and a first drive which is arranged in a housing and which is designed to execute a rotation of the clamping device of the machining table about a rotational axis,
a support member which is arranged on a pivot axle housing and on which the machining table is arranged,
wherein the support element is a one-sided hinged cantilever arm and having a substantially L-shaped form,
a three-axis linear motion system having a first linear axis Y, a second linear axis Z and a third linear axis X to allow relative motion between the Z-slider with the main spindle and the machining table,
a second drive, which is arranged to allow pivoting of the support member and the machining table about a pivot axis,
wherein the support member has a first leg and a second leg, and
wherein the machining table with the housing is arranged on the first leg at the free end of the first leg, such that the support member and the machining table can be pivoted about a pivot axis, that the support element and the housing substantially form a U-shaped unit and an interspace remains between the second leg and the housing, which interspace is designed as a workpiece receiving area for receiving a portion of the workpiece.

2. The machine tool according to claim 1, wherein the first drive is arranged in the machining table such that a drive axis of the first drive coincides with the rotational axis of the machining table.

3. The machine tool according to claim 1, wherein the support element, the machining table, the pivot axis housing, the first drive and the second drive form an assembly unit.

4. The machine tool according to claim 1, wherein the pivot axis of the support member is located in the machining plane of the machining table, or wherein the machining plane is located below the machining plane at a 0° position of the pivot axis.

5. The machine tool according to claim 1, wherein the pivot axis is perpendicular to the rotational axis.

6. The machine tool according to claim 1, wherein a diameter D1 of the housing of the machining table is greater than a width of the support element.

7. The machine tool according to claim 1, wherein the Z-slider is movable with the main spindle in the first linear axis Y and the second linear axis Z and/or wherein the Z-slider is oriented in the vertical direction.

8. Machine tool according to claim 1, wherein the workpiece is clampable to the clamping device by using a pallet, and wherein the workpiece is located substantially below the pallet in the 0° position of the swivel axis.

9. The machine tool according to claim 1, wherein the pivot axis housing is arranged on a carriage movable along the third linear axis X.

10. The machine tool according to claim 1, wherein a transition between the first leg and the second leg is arcuate.

11. The machine tool according to claim 1, wherein the housing of the machining table protrudes in the direction of the pivot axis beyond the free end of the first leg.

12. The machine tool according to claim 1, wherein a chamfer is formed at the free end of the first leg on a side opposite to the machining table.

13. The machine tool according to claim 1, wherein a cross section of the first leg of the support member is trapezoidal in shape such that a width at a top side where the machining table is arranged is wider than a width at an opposite bottom side.

14. The machine tool according to claim 1, wherein the housing of the machining table is cylindrical.

15. The machine tool according to claim 1, wherein a portion of the main spindle and a tool holding device mounted thereon including a tool is movable in the direction of the second linear axis below the pivot axis.
